(19) United States
(12) Patent Application Publication
(10) Pub. No.: US 2015/0148450 A1
(43) Pub. Date: May 28, 2015

(54) HALOGEN-FREE LOW-EXPANSION RESIN COMPOSITION

(71) Applicants: ITEQ CORPORATION, Ping Chen (TW); ITEQ (DONGGUAN) CORPORATION, Dongguan City (CN)

(72) Inventors: Feng Tang, Dongguan City (CN); Quansheng Zhu, Dongguan City (CN); Tsung-Lieh Weng, Dongguan City (CN); Yongxin Jiang, Dongguan City (CN); Hailin Li, Dongguan City (CN); Faquan Tu, Dongguan City (CN)

(21) Appl. No.: 14/088,440

(22) Filed: Nov. 24, 2013

(51) Int. Cl. C08L 63/10; C08L 63/00

(52) U.S. Cl. CPC C08L 63/10; C08L 63/00; C08L 2666/58
USPC 523/433

(57) ABSTRACT

Disclosed is a halogen-free low-expansion resin composition including a polyfunctional epoxy resin, a phosphorus-containing epoxy resin, a benzoxazine resin, a phosphorus-containing curing agent, an inorganic filler, a curing accelerator, and a solvent. The rigid and firm resins and inorganic filler contained in the composition provide a low coefficient of thermal expansion and a high heat resistance, so that laminates made of this composition are applicable for IC packaging substrates, and the laminates contain halogen-free compounds with a flame retardant rating of UL94-V0 grade.

### FIELD OF THE INVENTION

The present invention relates to a halogen-free low-expansion resin composition.

### BACKGROUND OF THE INVENTION

As digital technology advances, electronic products are generally developed with a light, thin, short and compact design and a high speed, and thus printed circuit boards (PCB) requires small and thin wire holes sizes and high precision and stable performance and low cost. Led by such trend, IC packaging technologies of the PCB also advance significantly from the conventional Plated Through Hole (PTH) Insertion by 1980's to the revolutionary Surface Mount Technology (SMT) from 1980 to 1993 and then to the present BGA, CSP and FC, and LGA becomes the main packaging method now. Since the packaging technology advances, the IC packaging substrates have increasingly higher requirements.

To satisfy the micro, high-density, and high-frequency technological requirements, the materials used for the IC substrate must have good heat resistance and low coefficient of thermal expansion. Since common FR-4 epoxy substrates have a high coefficient of thermal expansion and fail to satisfy the aforementioned requirements. Although special resins such as bismalimide-triazine (BT), polyphenylene ether (PPE) resin, and polytetrafluoroethylene (PTFE) resin have excellent coefficient of thermal expansion, yet the price much higher than the common substrate and the special manufacturing techniques restrict the development of the IC packaging significantly, so that it is an urgent need for related manufacturers to develop a low-cost IC packaging substrate for the market.

### SUMMARY OF THE INVENTION

In view of the aforementioned shortcomings of the prior art, it is a primary objective of the present invention to overcome the shortcomings by providing a halogen-free low-expansion resin composite, and a copper clad laminate made of the composition has the properties of low coefficient of thermal expansion, high heat resistance, low dielectric loss, high glass transition temperature and excellent flame retardation.

To achieve the aforementioned objective, the present invention provides a halogen-free low-expansion resin composition, comprising:
(a) a polyfunctional epoxy resin;
(b) a phosphorus-containing epoxy resin;
(c) a benzoxazine resin;
(d) a phosphorus-containing curing agent;
(e) an inorganic filler;
(f) a curing accelerator;
(g) a silane coupling agent;
wherein, the total weight of the compositions (a), (b), (c) and (d) is calculated according to 100 parts by mass, and the polyfunctional epoxy resin (a) occupies 10˜30 parts by mass; the phosphorus-containing epoxy resin (b) occupies 5-19 parts by mass;
the benzoxazine resin (c) occupies 8-29 parts by mass; and the phosphorus-containing curing agent (d) occupies 20˜47 parts by mass;
the inorganic filler (d) occupies 60%˜220% of the total weight of the compositions (a), (b) and (c);
the curing accelerator (e) occupies 0.01˜4% of the total weight of the compositions (a), (b) and (c); and
the silane coupling agent (f) occupies 0.01˜4% of the total weight of the compositions (a), (b) and (c).

The benzoxazine is a phenolphthalein benzoxazine with the following molecular structural formula:

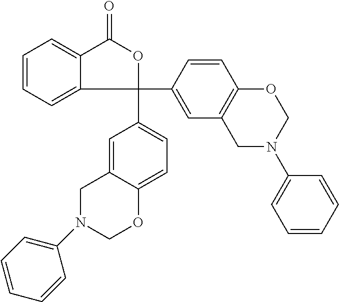 [SMILES: O=C1OC(c2ccc3c(c2)CN(c2ccccc2)CO3)(c2ccc3c(c2)CN(c2ccccc2)CO3)c2ccccc21]

The polyfunctional epoxy resin includes one or more epoxy resin selected from the group consisting of a trifunctional epoxy resin, a DCPD modified epoxy resin, a tetramethylbiphenyl epoxy resin, a biphenyl epoxy resin and a naphthalene ring epoxy with the following molecular structural formulas:

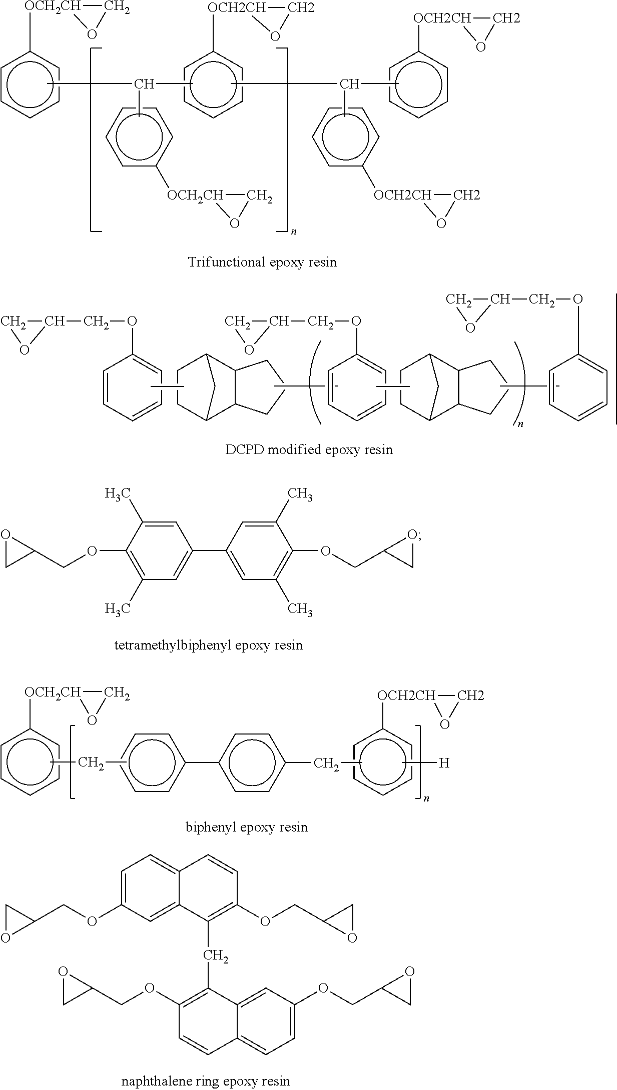

The phosphorus-containing epoxy resin is a modified epoxy resin with a DOPO or DOPO derivative structure.

The phosphorus-containing curing agent is a modified phenolic with a DOPO or DOPO derivative structure.

The inorganic filler includes one or more organic fillers selected from the group consisting of silica, silicon aluminate, spherical silica, kaolin and talcum powder.

The curing accelerator curing accelerator includes one or more imidazole curing accelerators selected from the group consisting of 2-methylimidazole, 2-ethyl-4-methylimidazole, 2-phenyl imidazole, and 2-undecylimidazole.

Compared with the prior art, the present invention has the following advantages and effects.

1. The composition of the present invention contains the benzoxazine resin with a rigid and heat-resisting phenolphthalein structure, while having a higher glass transition temperature than the common benzoxazine resin.

2. The composition of the present invention contains the polyfunctional epoxy resin with a naphthalene-ring or diphenyl rigid group structure capable of reducing the coefficient of thermal expansion of the rein positively, while providing good electric properties, high heat resistance, and high glass transition temperature.

3. The composition of the present invention contains the phosphorus-containing curing agent that provides good flame retardation, so that the flame retardant capability of the compound can reach the Grade VO standard.

4. The composition of the present invention contains the inorganic filler capable of reducing the coefficient of thermal expansion of the composition significantly, while lowering the cost and improving the flame retardation.

5. The copper clad laminates made of the composition is applicable for the packaging substrate and has the properties of low coefficient of thermal expansion, high heat resistance, high glass transition temperature (Tg), excellent flame retardation, and low dielectric loss.

### BRIEF DESCRIPTION OF THE DRAWINGS

None

### DESCRIPTION OF THE PREFERRED EMBODIMENTS

The aforementioned and other objectives and advantages of the present invention will become clearer in light of the following detailed description of an illustrative embodiment of this invention. It is intended that the embodiments disclosed herein are to be considered illustrative rather than restrictive.

A halogen-free low-expansion resin composite, comprising:
(A) an epoxy resin;
A1: a trifunctional epoxy resin;
A2: a DCPD modified epoxy resin;
A3: a biphenyl epoxy resin;
A4: a BPA epoxy resin;
(B) a phosphorus-containing epoxy resin;
B: a phosphorus-containing epoxy resin;
(C) a thermosetting resin having a major composition of dihydrobenzoxazine
compound;
C1: a phenolphthalein benzoxazine resin;
C2: a BPA benzoxazine resin;
(D) a phenolic resin
D1: a phosphorous-containing phenolic resin
D2: a linear phenolic resin
(E) an accelerant
E: Tetramethyl diethyl imidazole
(F) a coupling agent
F: silane coupling agent
(G) an inorganic filler
G1: a melted silica
G2: a spherical silica

The aforementioned resins are melted and mixed according to the proportion given in Table 1, and then dipped and coated onto an enhance fiberglass fabric, and baked in an oven at 171° C. for 3-5 min. to obtain a prepreg, and a 1-oz copper foil is placed separately on both top and bottom surfaces of eight prepregs, and the prepregs are put into a laminating machine to produce laminates, and the properties of these laminates are evaluated.

TABLE 1
Recipes of the Composition (1) (parts by mass)

| | Embodi- | Embodi- | Embodi- | Embodi- | Embodi- | Embodi- | Embodi- | Example of | Example of | Example of | Example of |
|---|---|---|---|---|---|---|---|---|---|---|---|
| Code | ment 1 | ment 2 | ment 3 | ment 4 | ment 5 | ment 6 | ment 7 | Control 1 | Control 2 | Control 3 | Control 4 |
| A1 | 25 | | 15 | 18 | 10 | 8 | 19 | | | 20 | |
| A2 | | 25 | | 10 | 5 | 10 | 9 | | | | |
| A3 | | | 7 | | | | | | | | |
| A4 | | | | | | | | 25 | 25 | | 35 |
| B | 18 | 10 | 15 | 18 | 19 | 15 | 15 | 15 | 15 | 15 | |
| C1 | 25 | 20 | 23 | 10 | 28 | 20 | 20 | | | 20 | 25 |
| C2 | | | | | | | | 20 | 20 | | |
| D1 | 32 | 45 | 40 | 44 | 38 | 47 | 37 | 40 | 40 | 45 | 19 |
| D2 | | | | | | | | | | | 21 |
| E | 0.1 | 0.1 | 0.1 | 0.1 | 0.1 | 0.1 | 0.1 | 0.1 | 0.1 | 0.1 | 0.1 |
| F | 0.5 | 0.6 | 0.6 | 0.6 | 0.6 | 0.5 | 0.6 | 0.6 | 0.6 | 0.6 | 0.6 |
| G1 | 85 | 90 | 100 | 100 | 100 | 140 | 115 | 40 | 100 | 20 | 100 |
| G2 | 15 | 20 | 20 | 20 | 20 | 30 | 25 | 0 | 20 | 10 | 20 |

TABLE 2
Evaluation of Properties (1)

| Condition | | Unit | Embodiment 1 | Embodiment 2 | Embodiment 3 | Embodiment 4 | Embodiment 5 |
|---|---|---|---|---|---|---|---|
| Peeling strength(Hoz) | | lb/in | 7.5 | 6.8 | 7.1 | 7.4 | 7.3 |
| Water Absorption Rate | PCT121° C.*1 hr | % | 0.48 | 0.40 | 0.42 | 0.45 | 0.45 |
| PCT(1 hr) + Dip | 288° C. | min | >10 | >10 | >10 | >10 | >10 |
| Float(Cu) | 288° C. | min | >10 | >10 | >10 | >10 | >10 |
| Tg | DSC | ° C. | 196 | 185 | 180 | 180 | 185 |
| T288 | Containing Copper | min | 35 | >60 | 30 | >60 | >60 |
| Df | 1 G | | 0.010 | 0.008 | 0.009 | 0.010 | 0.009 |
| CTE(%) | TMA | % | 1.8 | 1.70 | 1.7 | 1.7 | 1.6 |
| flame retardant | UL94 | | V0 | V0 | V0 | V0 | V0 |

TABLE 3
Evaluation of Properties (2)

| | | | | | Example of | Example of | Example of | Example of |
|---|---|---|---|---|---|---|---|---|
| Condition | | Unit | Embodiment 6 | Embodiment 7 | Control 1 | Control 2 | Control 3 | Control 4 |
| Peeling strength(Hoz) | | lb/in | 7.1 | 7.0 | 7.5 | 6.9 | 7.0 | 7.3 |
| Water Absorption Rate | PCT121° C.*1 hr | % | 0.35 | 0.39 | 0.54 | 0.38 | 0.38 | 0.38 |
| PCT(1 hr) + Dip | 288° C. | min | >10 | >10 | >10 | >10 | >10 | >10 |
| Float(Cu) | 288° C. | min | >10 | >10 | >10 | >10 | >10 | >10 |
| Tg | DSC | ° C. | 185 | 192 | 168 | 165 | 185 | 175 |
| T288 | Containing Copper | min | 35 | >60 | 35 | 40 | 20 | 15 |
| Df | 1 G | | 0.007 | 0.008 | 0.014 | 0.010 | 0.011 | 0.012 |
| CTE(%) | TMA | % | 1.3 | 1.5 | 3.0 | 2.3 | 2.5 | 2.8 |
| flame retardant | UL94 | | V0 | V0 | V0 | V0 | V0 | V1 |

The testing methods of the aforementioned properties are described below:

(1) Water Absorption Rate: It is a percentage of the weight difference before and after the PCT steaming process with respect to the sample weight before the PCT takes place.

(2) Thermal layer division time: The delamination layer division time is recorded, after the PCT is steamed for an hour at 121° C. in 105 KPa pressure cooker, and dipped in the solder pot at 288° C.

(3) Copper clad floating solder Float (Cu): The delamination time is measured when the solder (at 288° C.) of a copper clad laminate floats on a solder pot.

(4) Thermal layer division time T-288: It is measured according to the IPC-TM-650 2.4.24.1 method.

(5) Coefficient of thermal expansion Z-axis CTE (TMA): It is measure according to the IPC-TM-650 2.4.24 method.

(6) Glass transition temperature (Tg): It is measured according to the differential scanning calorimetry (DSC) and the DSC method as set forth by the IPC-TM-6502.4.25 regulation.

(7) Dielectric Loss Tangent: It is measured below 1 GHz by a parallel board method according to the IPC-TM-6502.5.5.9 regulation.

(8) Combustibility: It is measured by a vertical combustion method according to the UL 94 regulation.

In summation, the halogen-free low-expansion resin composition of the present invention contains no halogen, and the flame retardation reaches the UL94V-0 grade, and the copper clad laminate made of the composition and applied in the packaging substrate has the properties of very low coefficient of thermal expansion, high heat resistance, high glass transition temperature (Tg), excellent flame retardation and low dielectric loss.

While the invention has been described by means of specific embodiments, numerous modifications and variations could be made thereto by those skilled in the art without departing from the scope and spirit of the invention set forth in the claims.

What is claimed is:

1. A halogen-free low-expansion epoxy resin composition, comprising:
(a) a polyfunctional epoxy resin;
(b) a phosphorus-containing epoxy resin;
(c) a benzoxazine resin;
(d) a phosphorus-containing curing agent;
(e) an inorganic filler;
(f) a curing accelerator;
(g) a silane coupling agent;
wherein, the total weight of the compositions (a), (b), (c) and (d) is calculated according to 100 parts by mass;
the polyfunctional epoxy resin (a) occupies 10˜30 parts by mass;
the phosphorus-containing epoxy resin (b) occupies 5-19 parts by mass;
the benzoxazine resin (c) occupies 8-29 parts by mass;
the phosphorus-containing curing agent (d) occupies 20˜47 parts by mass;
the inorganic filler (d) occupies 60%˜220% of the total weight of the compositions of (a), (b) and (c);
the curing accelerator (e) occupies 0.01˜1% of the total weight of the compositions of (a), (b) and (c); and
the silane coupling agent (f) occupies 0.01˜1% of the total weight of the compositions of (a), (b) and (c).

2. The halogen-free low-expansion epoxy resin composition of claim 1, wherein the benzoxazine is a phenolphthalein benzoxazine with the molecular structural formula:

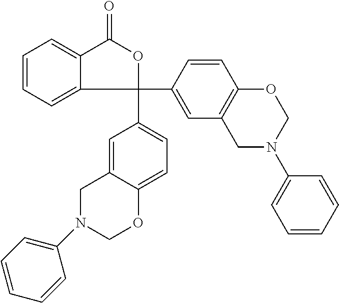 [SMILES: O=C1OC(c2ccc3c(c2)CN(c2ccccc2)CO3)(c2ccc3c(c2)CN(c2ccccc2)CO3)c2ccccc21]

3. The halogen-free low-expansion epoxy resin composition of claim 1, wherein the polyfunctional epoxy resin includes one or more epoxy resins selected from the group consisting of a trifunctional epoxy resin, a DCPD modified epoxy resin, a tetramethylbiphenyl epoxy resin, a biphenyl epoxy resin and a naphthalene ring epoxy resin, with the following molecular structural formula:

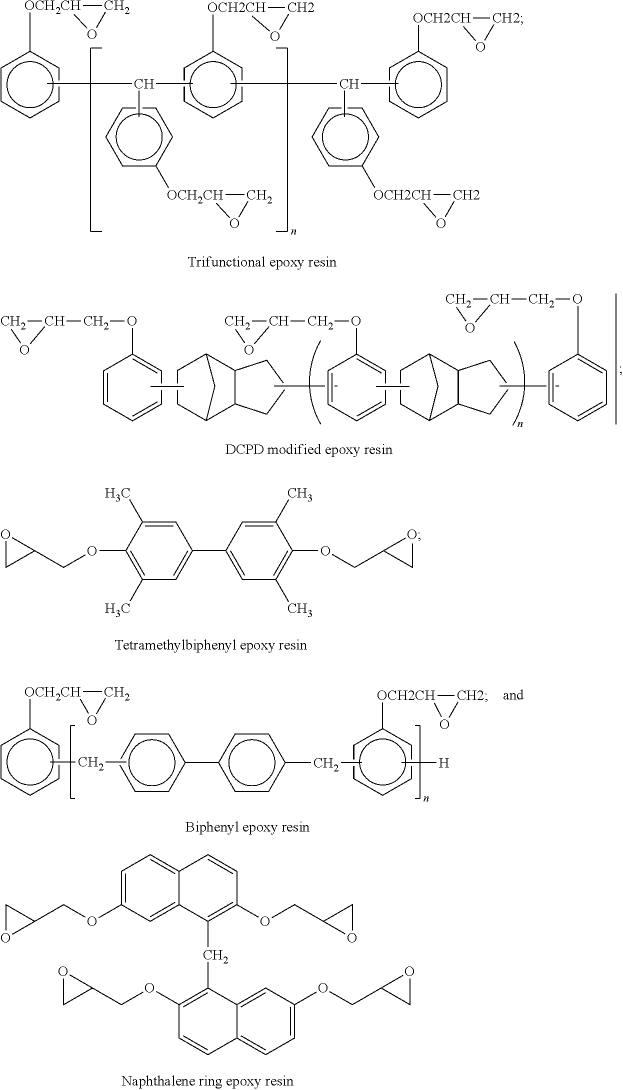

4. The halogen-free low-expansion epoxy resin composition of claim 1, wherein the phosphorus-containing epoxy resin is a modified epoxy resin with a DOPO or DOPO derivative structure.

5. The halogen-free low-expansion epoxy resin composition of claim 1, wherein the phosphorus-containing curing agent is a modified phenolic with a DOPO or DOPO derivative structure.

6. The halogen-free low-expansion epoxy resin composition of claim 1, wherein the inorganic filler includes one or more organic fillers selected from the group consisting of silica, silicon aluminate, spherical silica, kaolin and talcum powder.

7. The halogen-free low-expansion epoxy resin composition of claim 1, wherein the curing accelerator includes one or more imidazole curing accelerators selected from the group consisting of 2-methylimidazole, 2-ethyl-4-methylimidazole, 2-phenyl imidazole, and 2-undecylimidazole.
